(19) United States
(12) Patent Application Publication
(10) Pub. No.: US 2001/0005827 A1
(43) Pub. Date: Jun. 28, 2001

(54) Speech command-controllable electronic apparatus preferably provided for co-operation with a data network

(76) Inventor: Thomas Fiedler, Vienna (AT)

Correspondence Address: Corporate Patent Councel, U.S. Philips Corporation, 580 White Plains Road, Tarrytown, NY, 10591, US

(21) Appl. No.: 09/734,826

(22) Filed: Dec. 11, 2000

(30) Foreign Application Priority Data
Dec. 15, 1999 (EP) 99890389.2

(51) Int. Cl. G10L 11/00; G10L 21/00

(52) U.S. Cl. 704/275

(57) ABSTRACT

With an electronic apparatus (1), which can be controlled by control commands spoken by a user of the apparatus (1) and which includes speech signal input means (4) and control means (14) connected to the speech signal input means (4), the speech signal input means (4) can be adjusted in height and picture recording means (31) are provided by which a certain body area of a user of the apparatus (1) can be recorded, preferably the head area of the user, and picture evaluation means (33) are connected to the picture recording means (31) by which picture evaluation means (33) can be established whether the recorded body area lies within a nominal range (XY) and by which picture evaluation means (31) the speech signal input means (4) can be adjusted to bring the speech signal input means (4) into as optimal a position as possible relative to a user's mouth—for the case where the recorded body area does not lie within the nominal range (XY).

The invention relates to an electronic apparatus as defined in the introductory part of claim 1.

Such an electronic apparatus has been marketed by the applicants and is therefore known. The known apparatus comprises, in essence, an interface module and a personal computer electrically connected to the interface module and co-operating therewith, the interface module being attached, for example, to a wall or to a rack or any other fixture in a stationary manner, so that the interface module always has the same stationary position for all the users. The interface module contains speech signal input means for inputting speech signals which represent spoken speech commands.

With the known apparatus there is always the problem that the speech signal input means of the apparatus take up the same stationary position, which leads to the fact that the speech signal input means have an optimal position only for users having a body height in a relatively narrow target range. Such an optimal position of the speech signal input means relative to a user, however, is of great importance because only when such optimal position is present will a high recognition reliability be guaranteed during the recognition of the spoken speech commands. With the known apparatus there is therefore the problem with users having a smaller body height than the target range and users having a larger body height than the target range, the speech signal input means take up a relatively unfavorable position with respect to the mouth of this user, which leads to the fact that the entered speech signals which represent the spoken speech commands have a smaller quality value, which results in that the next speech signal recognition is less reliable and, therefore, problems may occur with the speech control of the apparatus.

It is an object of the invention to avoid the problems defined above and provide an improved electronic apparatus in accordance with the introductory part of claim 1.

For achieving the object defined above, with an electronic apparatus in accordance with the introductory part of claim 1 according to the invention the features in accordance with the characterizing part of claim 1 are provided.

By providing the features according to the invention there is achieved in a simple and reliable manner that the speech signal input means always have an optimal position relative to a user's mouth, irrespective of the user's body height. In this manner it is achieved that for each user a practically equally high reliability of recognition is guaranteed for the speech commands spoken by him, irrespective of whether the user is a short or a tall person.

With an apparatus according to the invention it has proved to be highly advantageous when, in addition, the features as claimed in claim 2 are provided. This guarantees an optimal signal reproduction for each user of the apparatus according to the invention, irrespective of the body height of the respective user.

With an apparatus according to the invention it has further proved to be highly advantageous when, in addition, the features as claimed in claim 3 are provided. They advantageously achieve that for each user, that is, irrespective of his body height, an ergonomically favorable and pleasant input of alphanumerical signs is ensured.

With an apparatus according to the invention it has further proved to be advantageous when, in addition, the features as claimed in claim 4 are provided. As a result, irrespective of a user's body height, it is ensured that a chip card can be simply and easily inserted into and taken away from the communication station of the apparatus.

In an apparatus according to the invention it has further proved to be highly advantageous when, in addition, the features as claimed in claim 5 are provided. As a result, irrespective of a user's body height, data on the display means of the apparatus can be read out in a pleasant and convenient way.

Furthermore, it has proved to be advantageous when, in addition, the feature as claimed in claim 6 is provided. As a result, with an apparatus according to the invention a separate keyboard will be superfluous.

The aspects defined above and further aspects of the invention emerge from the example of embodiment to be described hereinafter and will be further explained with reference to this example of embodiment.

These and other aspects of the invention are apparent from and will be elucidated with reference to the embodiments described hereinafter.

In the drawings:

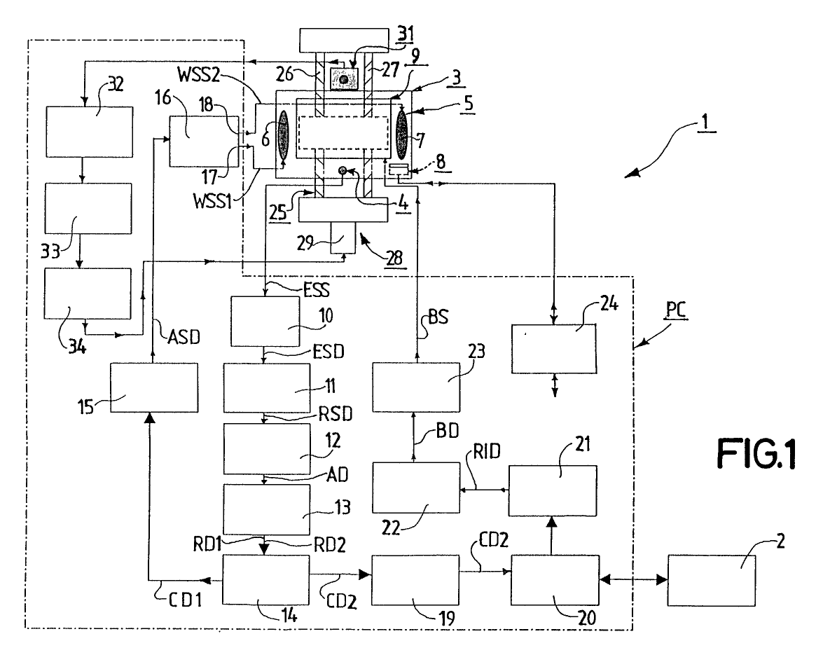

FIG. 1 shows diagrammatically and in essence in the form of a block diagram an electronic apparatus in accordance with an example of embodiment of the invention, and

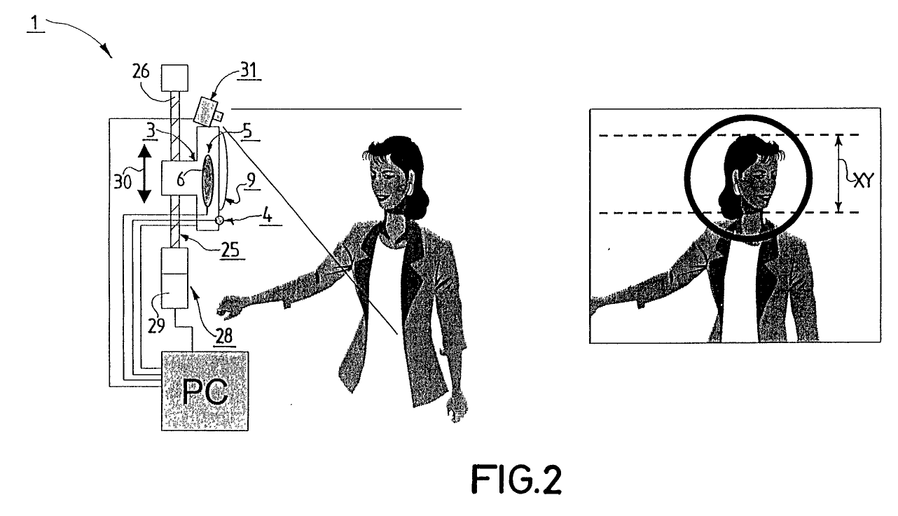

FIG. 2 shows the electronic apparatus as shown in FIG. 1 as well as the body area of a female user of this apparatus that can be recorded by image recording means of this apparatus, and the image of the body area of the female user recorded with the image recording means.

FIG. 1 shows an electronic apparatus 1, which will hereinafter be referred to for brevity as apparatus 1. The apparatus 1 is provided for connection to a data network 2 and adapted to retrieve data and information from the data network and receiving and displaying them optically and acoustically. In the present case the data network 2 is the so-called Internet. However, this may also be another data network, for example, the internal data network of an enterprise.

The apparatus 1 has several functions or modes of operation respectively. Each of these functions or modes of operation can be activated by spoken control commands, while each of these control commands can be spoken by a user of the apparatus 1 and in this way announced to the apparatus 1, and each of these control commands is formed by at least one spoken word. For example, such a control command formed by at least one spoken word may read “start” or “Hotels in Paris” or “Holiday resorts in Austria” or “air routes to New York”.

The apparatus 1 includes halting means 3 provided and arranged for halting a plurality of components of the apparatus 1, for halting speech signal input means 4 in essence in the form of a microphone, speech signal output means 5 in essence in the form of two loudspeakers 6 and 7, a communication station 8 for the contact-bound communication with a contact-bound chip card (not shown), display means 9 which are formed, in essence, by a touch-sensitive picture screen, while at the same time virtual input means can be realized by the display means 9 in that a keyboard can be shown on the display means 9, which keyboard can be used by touching visually represented keys of the keyboard to enter data, as this has been known for a long time. With the halting means 3 to which the speech signal input means 4 are mechanically connected, the speech signal input means 4 can be kept in a certain position relative to the user's mouth when a user is within range of the apparatus 1. The speech signal input means 4 are then provided for entering the speech signals, which represent the spoken speech commands in the apparatus 1.

The apparatus 1 comprises a personal computer PC with the aid of which a series of apparatus and means and functions are realized. Of all these possibilities, only the essential possibilities are further discussed in the present context.

In the personal computer PC is included an A/D converter 10, which is connected to the speech signal input means 4. To the A/D converter 10 are connected speech recognition means 11. To the speech recognition means 11 are connected speech evaluation means 12. To the speech evaluation means 12 are connected dialogue means 13. To the dialogue means 13 are connected control means 14. To the control means 14 are connected, on the one hand, speech output means 15, which are followed by a D/A converter 16 to whose two outputs 17 and 18 are connected the two loudspeakers 6 and 7 of the speech signal output means 5. To the control means 14 are also connected data transmission means 19 to which connecting means 20 are connected, which realizes a connection of the apparatus 1 to the data network 2. To the connecting means 20 are not only connected the data transmission means 19, but also data receiving means 21. To the data receiving means 21 are connected data processing means 22. To the data processing means 22 are connected picture signal output means 23, which are connected to the display means 9.

With the apparatus 1 can be performed—as already mentioned before—a plurality of functions, while the essential function for the apparatus 1 is that these functions can be activated and performed in a speech-controlled manner. For example, the apparatus 1 may be used for obtaining information about a timetable. This operation or this operating mode will be briefly explained hereinafter with reference to an example.

It is assumed that a user standing in front of the apparatus 1 wishes to have information about a timetable. For this purpose, the user speaks a control command, for example, the control command: “I would like to visit Wolfshoferamt and drive there”. This control command is received by the speech signal input means 4 and converted into a received speech signal ESS. The received speech signal ESS is applied to the A/D converter 10. The A/D converter provides a conversion of the received speech signal ESS into received speech data ESD. These received speech data ESD are applied to the speech recognition means 11 and recognized by them. As a result thereof, the speech recognition means 11 produce recognized speech data RSD. The recognized speech data RSD are applied to the speech evaluation means 12. The speech evaluation means 12 recognize that in the received speech data ESD, thus in the spoken control command, the destination is contained. This knowledge is sent to the dialogue means 13 in the form of evaluated data AD. The intelligent dialogue means 13 then recognize that the user has indicated the desired destination, it is true, but that for useful time table information are still lacking the place of departure, thus the start of the planned travel and the date (day and time of day). As a result, the dialogue means 13 produce representation data RD1 representing this lacking information, which data are applied to the control means 14. The representation data RD1 are processed in the control means 14 and, as a result, the control means 14 produce control data CD1. The control data CD1 are applied to the speech output means 15, which leads to the generation of speech data ASD by the speech output means 15, which speech data ASD correspond to the following text: “From what point of departure do you want to travel and on what day and at what time is the travel to take place?” The speech data ASD to be produced are applied by the speech output means 15 to the D/A converter 16, which provides a conversion into analog speech signals WSS1 and WSS2 of the speech data ASD to be output. These speech signals WSS1 and WSS2 which are analog and are to be reproduced are applied to the two loudspeakers 6 and 7 of the speech signal output means 5, which leads to the fact that via the two loudspeakers 6 and 7 the text mentioned above is reproduced to the user standing in front of the apparatus 1, that is: “From what point of departure do you want to travel and on what day and at what time is this to take place?”

Subsequently, the user gives a control command defined below in the form of several words with the aid of the speech signal input means 4 to the apparatus 1, that is: “I would like to leave from Gumpoldskirchen on the 28^{th} of August at about 9 o'clock in the morning”. This control command comprising a plurality of words is applied to the A/D converter 10 as a received speech signal ESS, after which a recognition procedure is carried out with the aid of the speech recognition means 11, so that again recognized speech data RSD are applied to the speech evaluation means 12. Subsequently, with the aid of the speech evaluation means 12 it is detected that not only the destination, but also the point of departure and the date (day and time) were entered by the user and thus all input data necessary for practical information about the time table are present. These facts are announced again to the dialogue means 13 in the form of evaluated data AD. The result is that the dialogue means 13 now generate further representation data RD2, which are applied to the control means 14. As a consequence of the further representation data RD2, the control means 14 generate further control data CD2 which determine what at least one Internet page is to be accessed, that is, the at least one Internet page from which the desired time table information can be taken. The further control data CD2 are conveyed to the data transmission means 19, which process the further control data CD2 and transport the processed control data CD2 to the connecting means 20. The connecting means 20 provide that the processed further control data CD2 are applied to the data network 2, thus to the Internet, after which these control data CD2 are evaluated on the Internet. As a result, the data network 2, thus the Internet supplies the requested data to the connecting means 20. The connecting means 20 subsequently apply received Internet data IED to the data receiving means 21. In the data receiving means 21 the received Internet data IED are regenerated, which leads to the fact that the data receiving means 21 deliver regenerated Internet data RID to the data processing means 22. The data processing means 22 provide that the regenerated Internet data RID are converted into picture data BD. The generated picture data BD are applied to the picture signal output means 23 which convert the generated picture data BD into picture signals BS, which signals BS are applied to the display means 9. As a result, the time table desired by the user is shown to him by the display means 9 informing him in a visually discernible way when and how he comes from the entered point of departure Gumpoldskirchen to the entered destination Wolfshoferamt.

It should be observed that with the procedure described above the user additionally has the option of feeding additional information to the apparatus 1 by means of the virtual input means realized by the display means. It should additionally be observed that for functions of the apparatus 1 for which a remuneration is desired, there is a possibility that a user inserts a check card into the communication station 8, while a certain amount of money can be debited with the aid of the interface means 24 contained in the personal computer PC.

As is evident from the FIGS. 1 and 2, the apparatus 1 includes guide means 25 which in the present case are formed by two screw-in spindles 26 and 27 running in parallel. With the aid of the guide means 25 the halting means 3 are guided, in essence, in vertical direction and can be adjusted along the guide means 25. Additionally, the apparatus 1 includes adjusting means 28 by means of which the halting means 3 can be adjusted along the guide means 25. In the present case the adjusting means 28 comprise a diagrammatically indicated electromotor 29 by which the two screw-in spindles 26 and 27 forming the guide means 25 can be driven in rotary fashion via a driving link not shown in the Figures. The two screw-in spindles 26 and 27 thus do not only form the component parts of the guide means 25, but also component parts of the adjusting means 28. With the aid of the two screw-in spindles 26 and 27, the halting means 3 can thus be adjusted and set. Such adjusting means 28 have been known for a long time. With the aid of the adjusting means 28 can be adjusted the halting means 3 in parallel with the double arrow 30 shown in the FIG. 2.

In the apparatus 1 are advantageously additionally provided picture recording means 31, which are formed, in essence by a video camera. The picture recording means 31 are mechanically connected to the halting means 3, which leads to the fact that the picture recording means 31, together with the halting means 3, can be adjusted in vertical direction in parallel with the direction of the arrow 30. With the aid of the picture recording means 31 can be recorded a certain body area of a user of the apparatus 1 as this can be learnt from the FIG. 2. In accordance with FIG. 2 it is assumed that with the aid of the picture recording means 31 the head area and, additionally, at least part of the upper body of a female user can be recorded.

As is evident from FIG. 1, picture recognition means 32 are connected to the picture recording means 31 of the apparatus 1. Picture evaluation means 33 are connected to the picture recognition means 32. Adjustment control means 34 are connected to the picture evaluation means 33. The motor 29 of the adjusting means 28 is connected to the adjustment control means 34.

With the picture evaluation means 33 can be established whether the recorded body of a user lies within a nominal range XY. In case of deviations of the position of the recorded body area relative to the nominal range XY, the adjusting means 28 can be controlled by the picture evaluation means 33 to adjust the halting means 3 and, consequently, to adjust the speech signal input means 4 connected thereto and the picture recording means 31, to move the picture recording means 31 in parallel with the double arrow 30, so that the recorded body area of a user standing in front of the apparatus 1 lies within the nominal range XY.

When the apparatus 1 is in operation—as this is shown in FIG. 2—a certain body area of a user can be recorded by the picture recording means 31, so that a recorded picture is obtained, as this is shown in the right-hand portion of FIG. 2. The picture recorded by the picture recording means 31 is applied to the picture recognition means 32, where the picture signals are converted into picture data by the picture recognition means 32. The picture data generated by the picture recognition means 32 are applied to the picture evaluation means 33. With the picture evaluation means 33 there can be established in the apparatus 1 whether the head of a user recorded by the picture recording means 31 lies within the nominal range XY, which nominal range XY is shown in the right-hand part of FIG. 2. When the recorded head area of a user of the apparatus 1 lies within the nominal range XY, it leads to the fact that the speech signal input means 4 are in an advantageous favorable position relative to the user's mouth. In that case, no further measures for improvement are necessary. However, when the recorded head area lies outside the nominal range XY, this is detected by means of the picture evaluation means 33. As a result, the picture evaluation means 33 apply control information to the adjusting means control means 34, which control information leads to the fact that with the aid of the adjusting means 28 the halting means 3 are adjusted in parallel with the direction of the double arrow 30, so that the picture recording means 31 are adjusted and, as a consequence of this adjustment, the recorded head area of a user lies within the nominal range XY. As a result of this adjustment of the halting means 3 it is achieved that the speech signal input means 4 halted by the halting means 3 are also adjusted in parallel with the direction of the double arrow 30, which in its turn leads to the fact that the speech signal input means 4 are brought to a favorable position relative to a user's mouth.

The operation of the apparatus 1 described above advantageously achieves that the speech signal input means 4 always take up an advantageous favorable position relative to the mouth of a respective user of the apparatus 1, irrespective of the user's body height, which leads to the fact that the respective user's speech signals spoken as control commands are received with a practically equally high signal quality by the speech signal input means 4 and converted into received speech signals ESS, which in its turn leads to the fact that the received speech data ESD corresponding to the received speech signals ESS have the same quality irrespective of the respective user's height. In this manner, it is achieved that for each user of the apparatus 1 a practically equally high recognition reliability is guaranteed for the speech commands spoken by the respective user.

It is maintained that the above-described apparatus for co-operation with the Internet is an advantageous example of embodiment according to the invention, that the measures according to the invention, however, may also be utilized to advantage with other electronic apparatus that can be controlled by speech commands.

1. An electronic apparatus (1) comprising functions which may be activated by control commands of which each one is formed at least by one spoken word from a user of the apparatus (1), and including speech signal input means (4) for inputting speech signals into the apparatus (1) which represent the spoken speech commands and including control means (14) connected to the speech signal input means (4) by which control means (14) can be generated control data (CD2) representing a speech command, and including halting means (3) to which the speech signal input means (4) are mechanically connected, so that the speech signal input means (4) in the presence of a user take up a certain position relative to the user's mouth, characterized in that the apparatus (1) includes guide means (25) by which the halting means (3) are at least in essence guided in vertical direction and in that the apparatus (1) includes adjusting means (28) by which the halting means (3) can be adjusted along the guide means (25), and in that picture recording means (31) are provided which are mechanically connected to the halting means (3) and by which a certain body area of a user can be recorded, and in that picture evaluation means (33) are provided by which can be established whether the recorded body area lies within a nominal range (XY) and in that in the event of deviations of the position of the recorded body area relative to the nominal range (XY) the adjusting means (28) are provided for adjusting the halting means (3) and, consequently, the connected speech signal input means and picture recording means (31) can be driven by the picture evaluation means (33) to adjust the picture recording means (31) so that the recorded body area lies within the nominal range (XY).

2. An apparatus (1) as claimed in claim 1, characterized in that the apparatus (1) additionally includes speech signal output means (5) for delivering speech signals and in that the speech signal output means (5) are mechanically connected to the halting means (3).

3. An apparatus (1) as claimed in claim 1, characterized in that the apparatus (1) includes input means (9) for inputting alphanumerical signs and in that the input means (9) are mechanically connected to the halting means (3).

4. An apparatus (1) as claimed in claim 1, characterized in that the apparatus (1) includes a communication station (8) for contact-bound communication with a contact-bound chip card and in that the communication station (8) is mechanically connected to the halting means (3).

5. An apparatus (1) as claimed in claim 1, characterized in that the apparatus (1) includes display means (9) for displaying data and in that the display means (9) are mechanically connected to the halting means (3).

6. An apparatus (1) as claimed in claim 5, characterized in that virtual input means can be realized with the display means (9).
